(19) United States
(12) Patent Application Publication
(10) Pub. No.: US 2016/0165280 A1
(43) Pub. Date: Jun. 9, 2016

(54) CONTENT PLAYER DEVICE AND CONTENT PLAYING METHOD

(71) Applicant: KABUSHIKI KAISHA TOSHIBA, Tokyo (JP)

(72) Inventor: Keiko WATANABE, Tokyo (JP)

(73) Assignee: KABUSHIKI KAISHA TOSHIBA, Tokyo (JP)

(21) Appl. No.: 15/013,240

(22) Filed: Feb. 2, 2016

Related U.S. Application Data
(63) Continuation of application No. PCT/JP2013/079596, filed on Oct. 31, 2013.

(51) Int. Cl. H04N 21/254; H04N 21/6334; H04N 21/4405; H04N 21/426; H04N 21/4408; H04N 21/4627; H04N 21/266

(52) U.S. Cl. CPC H04N 21/2541; H04N 21/4627; H04N 21/6334; H04N 21/26613; H04N 21/42669; H04N 21/4408; H04N 21/4405

(57) ABSTRACT

According to one embodiment, a content player device connects a license server with a removable memory device in a mutually authenticated manner, writes a preliminarily provided base data to a protected area of the removable memory device and a sub data to a data write area of the removable memory device using a command which allows a write only in an authentication mode, performs mutual authentication with the removable memory device, selects a cryptographic key from the group of cryptographic keys of the base data written to the protected area on the basis of the sub data written to the data write area if the authentication is confirmed, and decrypts encrypted content distributed by a content server on the basis of the cryptographic key.

### CROSS REFERENCE TO RELATED APPLICATIONS

This application is a Continuation application of PCT Application No. PCT/JP2013/079596, filed Oct. 31, 2013, the entire contents of which are incorporated herein by reference.

### FIELD

Embodiments described herein relate generally to a content player device for streaming play of content and content playing method.

### BACKGROUND

Conventionally, there is a system which can perform direct mutual authentication between a rights server configured to distribute rights data of content and a removable memory device with a copyright protection function with respect to recorded content therein with a player device which can record/play the content in the removable memory device. In such a system, the rights data and encrypted content are directly downloaded from the rights server to the removable memory device, and then, the player device performs mutual authentication with the removable memory device to acquire the rights data. The player device plays the content while decrypting the encrypted content from the removable memory device.

In such a system, the encrypted content must be downloaded to the removable memory device. If the content is archived for repeated use, the downloading and recording process of the encrypted content is reasonable. However, if the content is downloaded, recorded in, and erased from the removable memory device for a few viewings, such a use may degrade flash memory elements of the removable memory device, and is unreasonable.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram which schematically shows an example of a content playing system of an embodiment.

FIG. 2 is a block diagram which schematically shows an example of a signal processing system of a player device as a digital television broadcast receiver of a content playing system of the embodiment.

FIG. 3 is a block diagram which shows an example of functional blocks of typical operations of the player device of the content playing system of the embodiment.

FIG. 4 shows an example of a streaming play sequence performed in the content playing system of the embodiment.

FIG. 5 shows another example of a streaming play sequence performed in the content playing system of the embodiment.

FIG. 6 shows still another example of a streaming play sequence performed in the content playing system of the embodiment.

### DETAILED DESCRIPTION

Various embodiments will be described hereinafter with reference to the accompanying drawings.

In general, according to one embodiment, there are provided a content player device includes a memory, one or more hardware processors, a first transceiver and a second transceiver. The one or more hardware processors is coupled to the memory. The first transceiver is coupled to the one or more hardware processors and configured to be connected to an external network. The second transceiver is coupled to the first transceiver and configured to be connected to a removable memory device, the removable memory device being configured to be connected to a license server on the external network in a mutually authenticated manner via the first and second transceiver if the removable memory device is connected to the second transceiver, the license server being configured to distribute base data used for generating a cryptographic key and sub data which generate the cryptographic key on the basis of the base data, and the removable memory device being configured to receive the base data and the sub data from the license server if the removable memory device is connected to the second transceiver, wherein the one or more hardware processors are configured to, write the preliminarily provided base data to a protected area of the removable memory device and write the sub data to a data write area of the removable memory device in response to a command which allows a write only in an authentication mode, and perform mutual authentication with the removable memory device, to generate a cryptographic key on the basis of the base data written to the protected area of the removable memory device and the sub data written to the data write area if the authentication is confirmed, and decrypts encrypted content distributed by a content server on the basis of the cryptographic key for performing streaming play of the content.

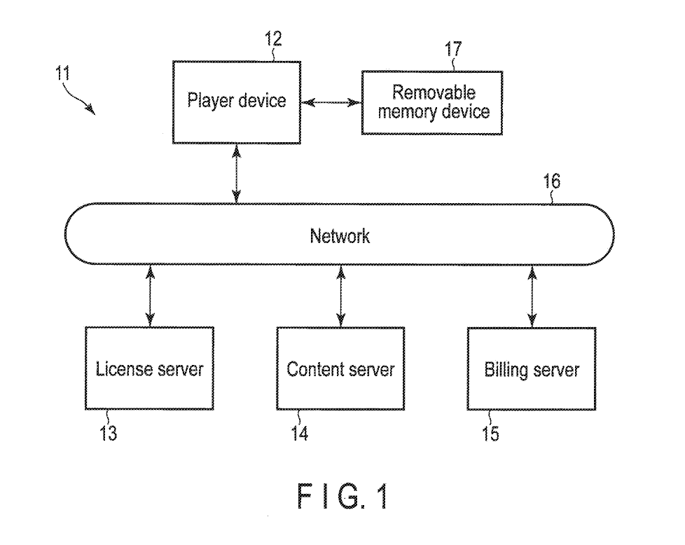

FIG. 1 schematically shows an example of a content playing system 11 of the present embodiment. The content playing system 11 includes, for example, a player device 12, license server 13, content server 14, and billing server 15 which are connected to a network 16 such as Internet, for example.

The player device 12 may be a digital television broadcast receiver including, for example, a video display screen and speaker, or a set-top box (STB) which is connectable to, for example, an external video display and a speaker. The player device 12 can selectively perform communication with the license server 13, content server 14, and billing server 15. Furthermore, the player device 12 can be connected to a removable memory device 17 such as a secure digital (SD) memory card. The connection can be made through various schemes such as a slot, tray, cable, and wireless.

The license server 13 provides the player device 12 with, for example, a cryptographic key used for decrypting encrypted content and rights data including a use rule in which content use permission conditions and the like are described. In this embodiment, the license server 13 provides a cryptographic key (content key) by providing a service key (base data) at the time of making a service agreement and sending auxiliary data (sub data) which generates the cryptographic key on the basis of the service key at the time of receiving encrypted content from the content server 14. The content server 14 provides the player device 12 with the content encrypted using the cryptographic key. The billing server 15 performs a billing process with respect to charges for paid content requested by a user, for example. Note that, although the license server 13, content server 14, and billing server 15 are separated in the present application, a single server may perform the functions of these servers.

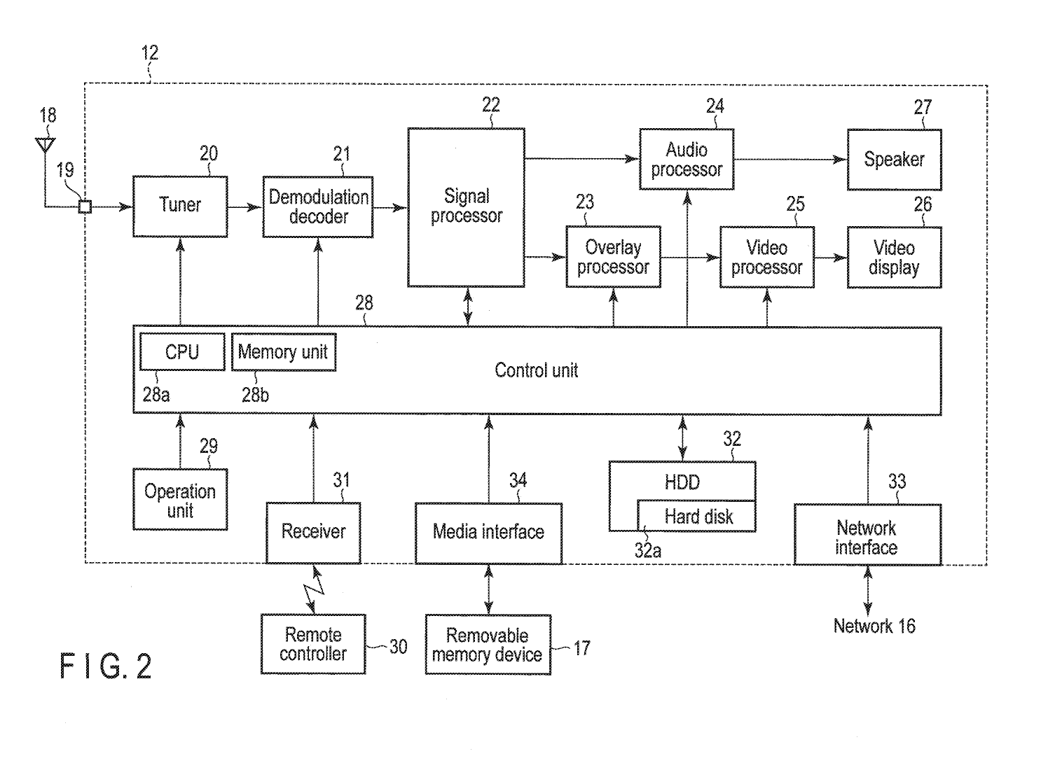

FIG. 2 schematically shows an example of a signal processing system of the player device 12. In FIG. 2, the player device 12 is a digital television broadcast receiver. That is, digital television broadcast signals received by an antenna 18 are supplied to a tuner 20 through an input terminal 19, and the broadcast signal of a desired channel is selected.

The broadcast signal selected by the tuner 20 is supplied to a demodulation decoder 21 to be restored to, for example, digital video signals and digital audio signals and output to a signal processor 22. The signal processor 22 performs a predetermined digital signal processing of the digital video signals and the digital audio signals supplied from the demodulation decoder 21.

Then, the signal processor 22 outputs the digital video signals to an overlay processor 23 and outputs the digital audio signals to an audio processor 24. The overlay processor 23 superimposes on-screen display (OSD) signals on the digital video signals supplied from the signal processor 22.

The overlay processor 23 outputs the digital video signals to a video processor 25, and the video processor 25 converts the digital video signals to analogue video signals such that a video display 26 can later use the signals for video display. The video processor 25 outputs the analogue video signals to the video display 26 for displaying video.

The audio processor 24 converts the digital audio signals to analogue audio signals such that a speaker 27 can later use the signals for audio reproduction. The audio processor 24 outputs the analogue audio signals to the speaker 27 for reproducing audio.

The player device 12 is controlled by a control unit 28 with respect to various operations including the above reception operations. The control unit 28 includes a central processing unit (CPU) 28a. The control unit 28 receives operation data from an operation unit 29 provided with the main body of the player device 12 or operation data from a remote controller 30 and received by a receiver unit 31 and controls each component to function on the basis of the received operation data.

In that case, the control unit 28 uses a memory unit 28b. The memory unit 28b mainly includes a read-only memory (ROM) which stores a control program executed by the CPU 28a, random access memory (RAM) which provides a workspace for the CPU 28a, and nonvolatile memory which stores various items of configuration data, control data, and the like.

Furthermore, the control unit 28 is connected to a hard disk drive (HDD) 32. In accordance with user operations received by the operation unit 29 and the remote controller 30, the control unit 28 supplies the digital video data and digital audio data from the signal processor 22 to the HDD 32, encrypts and converts the data into a predetermined recording format, and records the converted encrypted data on a hard disk 32a.

Furthermore, in accordance with user operations received by the operation unit 29 and the remote controller 30, the control unit 28 instructs the HDD 32 to read and decrypt the digital video data and digital audio data from the hard disk 32a and supplies the decrypted data to the signal processor 22 for the above-described displaying video and playing audio.

Furthermore, the control unit 28 is connected to a network interface 33. The network interface 33 is connected to the network 16. Therefore, in accordance with user operation received by the operation unit 29 and the remote controller 30, the control unit 28 can access the license server 13, content server 14, and billing server 15 through the network interface 33 and the network 16 for data communication.

Furthermore, the control unit 28 is connected to a media interface 34. The media interface 34 can be connected to the removable memory device 17. Therefore, in accordance with user operation received by the operation unit 29 and the remote controller 30, the control unit 28 can perform data communication with the removable memory device 17 through the media interface 34.

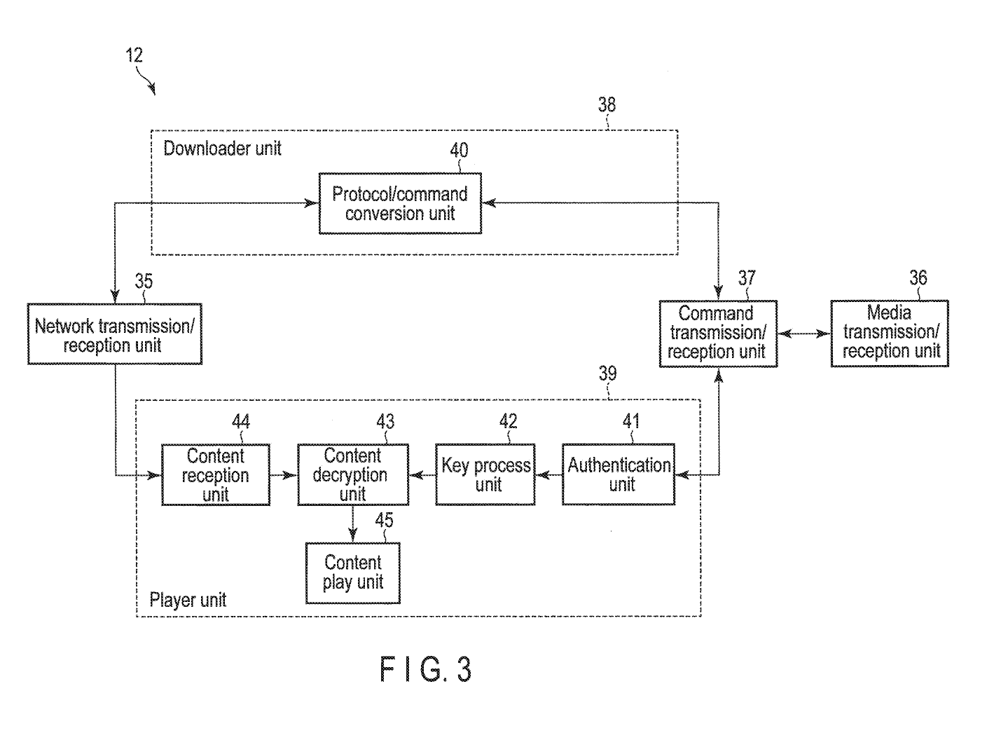

FIG. 3 shows an example of a signal processing system of the player device 12 as a functional block diagram of typical operations of the present embodiment. As explained above, the player device 12 includes a network transmission/reception unit (which corresponds to the network interface 33) 35 for the connection with the network 16. Furthermore, the player device 12 includes a media transmission/reception unit (which corresponds to the media interface 34) 36 for the connection with the removable memory device 17.

The removable memory device 17 may be, for example, an SD memory card. At the time of data transmission to the removable memory device 17, the player device 12 generates, for example, data packets of command data in a command transmission/reception unit 37 and transmits the data packets to the removable memory device 17 through the media transmission/reception unit 36. Furthermore, at the time of data reception from the removable memory device 17, the player device 12 interprets a response and data packets of the data received through the media transmission/reception unit 36.

When making a service agreement or the like, a service key output from the license server 13 is written to a protected area of the removable memory device 17. Note that the service key may be a key active only for a month and reissued or a key active only for download/streaming of a predetermined number of content items; however, specifics of the service key are not limited thereto. At the time of streaming distribution of the content, the server 13 does not distribute a title key to the removable memory device 17 but writes auxiliary data to a data write area of the removable memory device 17 using a GetStatus command. A write using a GetStatus command is only performable by a host in an authentication mode. Note that the data written here can be read by both a host in an authentication mode and a host not in an authentication mode. That is, auxiliary data are written to an unprotected area but are not necessarily read from the unprotected area. A title key can be generated from the auxiliary data and the service key.

The player device 12 can roughly be divided into a downloader unit 38 and a player unit 39. The downloader unit 38 performs, basically, a protocol/command conversion to associate the protocol of the network 16 with the command transmitted/received from/by the removable memory device 17 at the time of performing communication including authentication and the like between the license server 13 and content server 14 and the removable memory device 17.

The above protocol/command conversion process is performed by a protocol/command conversion unit 40 in the downloader unit 38. The protocol/command conversion is required because the packets used for the communication such as authentication have different formats.

The player unit 39 performs a content play process. When the content play process is initiated, an authentication unit 41 first performs an authentication process with the removable memory device 17 through the command transmission/reception unit 37.

After mutual authentication is confirmed, a key process unit 42 acquires a service key from the protected area of the removable memory device 17 and auxiliary data written to the data write area, generates a title key from the auxiliary data on the basis of the service key, and transmits the title key to a content decryption unit 43.

A content reception unit 44 of the player unit 39 receives content from the content server 14. In the rights data, a URL designating the address of the content with respect to the content server 14 is included. The content reception unit 44 accesses the content server 14 designated by the URL to obtain encrypted content.

Note that distribution and acquisition of the rights data including the URL can be achieved through various methods. For example, the license server 13 may write a URL in the removable memory device 17 using a GetStatus command in a mutual authentication step such as S18 and S24, and the player unit 39 may acquire the written URL in a message acquisition step such as S20 and S26. Alternatively, the license server 13 and the removable memory device 17 may perform mutual authentication after step S15 (not shown) to write a URL in the removable memory device 17, and the player unit 39 may acquire the URL in step S16. Alternatively, the content server 14 or the license server 13 may report a URL to the player unit 39 designated by content determination in step S12.

Protocols such as Hypertext Transfer Protocol (HTTP) and Real-Time Transport Protocol (RTP) are used as the protocol for transferring encrypted content between the content server 14 and the player device 12. The content reception unit 44 can receive the content encrypted at a speed corresponding to a content playing speed of the player unit 39. Furthermore, the content reception unit 44 can receive only the part required from the whole content corresponding to a control function such as fast-forwarding and chapter-jumping.

The encrypted content received by the content reception unit 44 is sent to the content decryption unit 43. The encrypted content is decrypted therein using the title key. Here, the decryption of the content is executed in a complementary mode of the Advanced Encryption Standard (AES), for example. The encrypted content is decrypted on the basis of a predetermined format. The decrypted content can be played by a content play unit 45.

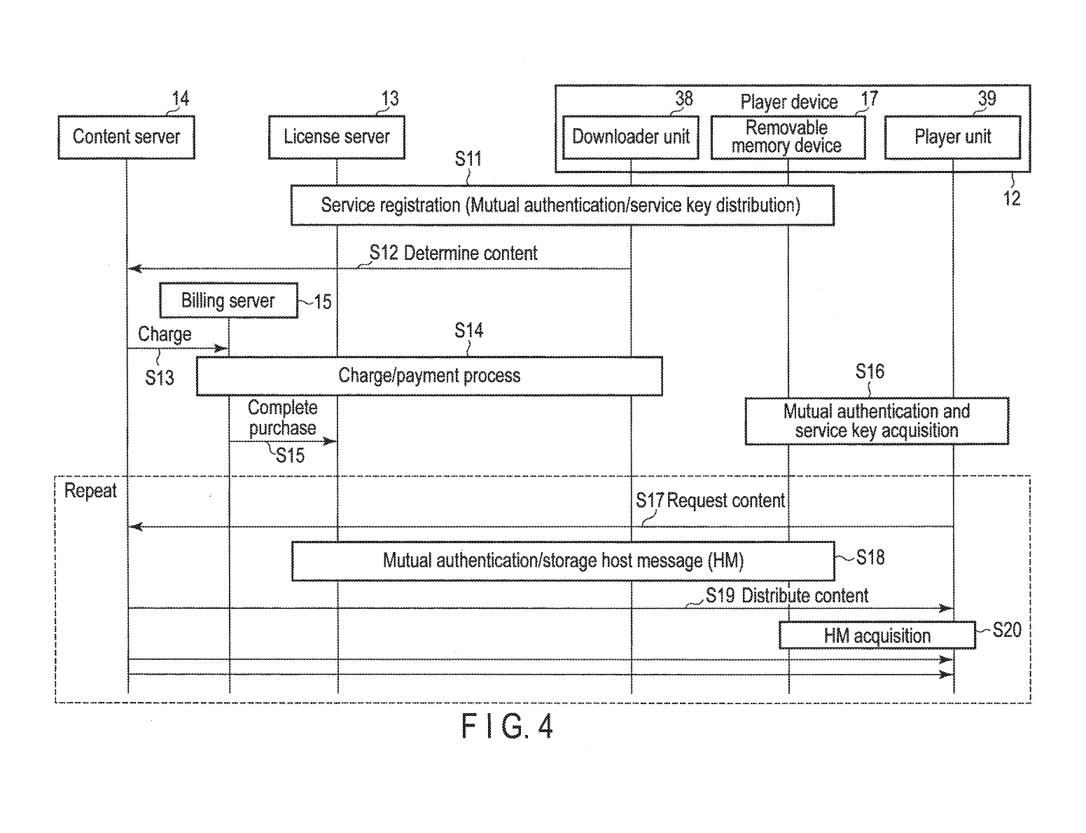

FIG. 4 shows an example of a streaming play sequence using the removable memory device 17. The structural elements thereof are, as in FIG. 1, the content server 14, billing server 15, license server 13, and player device 12. Furthermore, the player device 12 includes the downloader unit 38 and the player unit 39 which perform different processes. Furthermore, a removable memory device 17 is connected to the player device 12.

First, in step S11, the license server 13 and the removable memory device 17 perform mutual authentication before starting streaming (when making a service agreement or a payment), a service key output from the license server 13 is written to the protected area of the removable memory device 17.

Here, in step S12, the downloader unit 38 of the player device 12 communicates with the content server 14 to select content to be viewed. The content server 14 provides a list of content which can be provided with the downloader unit 38 of the player device 12. Then, the downloader unit 38 reports the content selected by a user from the list for viewing to the content server 14.

Then, in step S13, the content server 14 performs a billing process for the content selected by the user. That is, the content server 14 requests the billing server 15 to charge the user for the content selected.

Then, in step S14, the charge and payment process with respect to the user is made between the billing server 15 and the downloader unit 38. If this step is completed without a problem, a notice of completion of the payment process is sent from the billing server 15 to the license server 13 in step S15.

In step S16, upon receiving an instruction of initiating streaming play, the player unit 39 performs mutual authentication with the removable memory device 17 to acquire a service key.

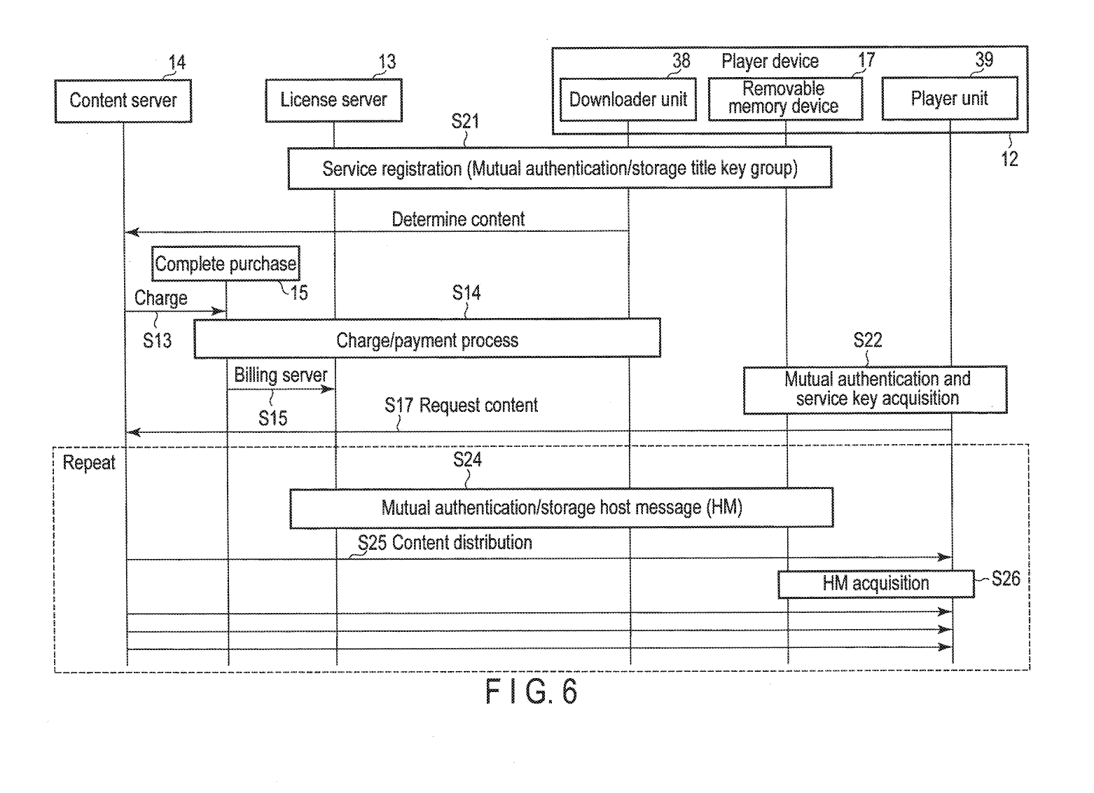

Then, in step S17, the play unit 39 sends a content request to the content server 14, and in step S18, the content server 14 performs mutual authentication with the removable memory device 17 and writes auxiliary data to the data write area of the removable memory device 17. Note that, in FIGS. 4 and 6, the auxiliary data written by the GetStatus command are represented as a host message.

Then, in step S19, encrypted content is distributed from the content server 14 to the player unit 39. Then, in step S20, the player unit 39 acquires the auxiliary data from the removable memory device 17 and generates a content key from the auxiliary data on the basis of the service key. Then, the player unit 39 decrypts the distributed encrypted content for play.

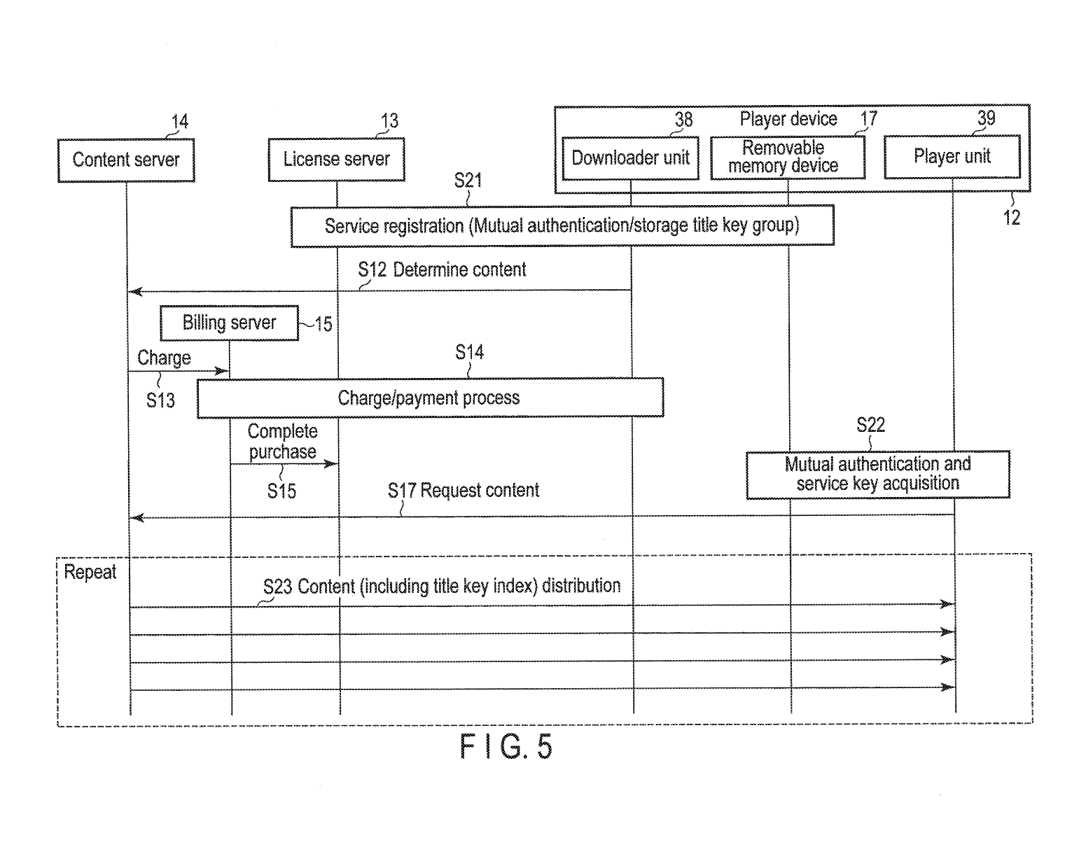

FIG. 5 shows another example of the streaming play sequence of FIG. 4. In this example, the license server 13 distributes a title key group including a plurality of title keys when a user performs service registration and a title key index is included in the content distributed by the content server 14 at the time of content distribution such that a change of title key is instructed in the streaming play.

In FIG. 5, the steps corresponding to that of FIG. 4 are referred to by the same reference numbers. In step S21, after the mutual authentication at the time of service registration, a title key group including a plurality of title keys output from the license server 13 is written to the protected area of the removable memory device 17.

Then, after the charge and payment process in step S14 is performed, the player unit 39 performs mutual authentication with the removable memory device 17 and acquires the title key group from the removable memory device 17 in step S22. Then, after the content request of step S17, the content distribution is performed in step S23 with a title key index in the content. A title key designated by the index is selected, and distributed encrypted content can be decrypted using the title key for play.

Here, a change of the title key is triggered when the number of streamed bytes reaches a predetermined value, or triggered by data indicative of a change of the title key included in the stream, for example. Which title key is used is determined on the basis of the title key index included in the stream. The number of bytes is changed at predetermined intervals to notify a change of the title key. The change of the title key is performed sequentially according to the title key index.

FIG. 6 shows still another example of the streaming play sequence of FIG. 5. In this example, the license server 13 distributes a title key group including a plurality of title keys when a user performs service registration and auxiliary data including a title key index are written in the removable memory device using the above mentioned GetStatus command at the time of content distribution by the content server 14 such that a change of title key is instructed in the streaming play.

In FIG. 6, the steps corresponding to that of FIG. 5 are referred to by the same reference numbers. In step S21, after the mutual authentication at the time of service registration, a title key group including a plurality of title keys output from the license server 13 is written to the protected area of the removable memory device 17.

Then, after the charge and payment process in step S14 is performed, the player unit 39 performs mutual authentication with the removable memory device 17 and acquires the title key group from the removable memory device 17 in step S22.

Then, the player unit 39 requests content from the content server 14 in step S17 and the content server 14 performs mutual authentication with the removable memory device 17 in step S24. The content server 14 writes a title key index to the data write area of the removable memory device 17 using the above GetStatus command.

Then, after the request for the content, a content distribution is received in step S25, a title key designated by the index written in a data storage area is selected in step S26, and encrypted content distributed thereby is decrypted using a content key for play.

Note that the license server 13 may write a title key index to the removable memory device 17 during the content distribution. That is, change instruction data which instruct a change of the title key in a predetermined play point may be included in the content stream, and a title key index which changes corresponding to the change instruction data may be written in the removable memory device 17 before distribution of the change instruction data. Upon receipt of the change instruction data, the player unit 39 acquires the title key index in step S26 and uses the title key indicated by the index from the protected area of the removable memory device 17 for decryption. Furthermore, the license server 13 and the player device 12 may be set to change a title key at a position of a predetermined number of streamed bytes. In that case, step S26 is performed at the position of a predetermined number of streamed bytes and the content key is changed.

Note that data such as content payment history and a removable memory device ID of the removable memory device 17 as an address where a title key is generated or selected may be associated with each other and stored in the license server 13. Thereby, the license server 13 stores the removable memory device ID of the removable memory device 17 to which data has been provided before even if data relating to the title key are deleted by reformat of the removable memory device 17. Thus, the removable memory device 17 and the license server 13 which share the same removable memory device ID can perform mutual authentication without performing a charge and payment process again, and data can be provided with the removable memory device 17.

Furthermore, a plurality of removable memory device IDs may be registered in a single account of an end user in the license server 13. Thereby, the license server 13 may recognize that rights data has already been downloaded when a rights data request is sent from the removable memory device 17 including any one of the registered removable memory device IDs, and the rights data can be provided with the removable memory device 17 again without performing a change and payment process.

In the above embodiment, base data for generating or selecting a title key are recorded in the removable memory device 17 as rights data, and on the basis of the base data, a cryptographic key is generated or selected in the player device 12 from sub data provided at the time of content distribution. Streaming play is performed while decrypting encrypted content distributed from the content server 14 using the cryptographic key, and thus, encrypted content of massive volume is not required to be recorded in the removable memory device 17. Therefore, deterioration of the recording elements of the removable memory device 17 can be suppressed and the product durability of the removable memory device 17 can be maintained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content player device comprising:
a memory;
one or more hardware processors coupled to the memory;
a first transceiver coupled to the one or more hardware processors and configured to be connected to an external network; and
a second transceiver coupled to the first transceiver and configured to be connected to a removable memory device, the removable memory device being configured to be connected to a license server on the external network in a mutually authenticated manner via the first and second transceiver if the removable memory device is connected to the second transceiver, the license server being configured to distribute base data used for generating a cryptographic key and sub data which generate the cryptographic key on the basis of the base data, and the removable memory device being configured to receive the base data and the sub data from the license server if the removable memory device is connected to the second transceiver, wherein the one or more hardware processors are configured to:
write the preliminarily provided base data to a protected area of the removable memory device and to write the sub data to a data write area of the removable memory device in response to a command which allows a write only in an authentication mode; and
perform mutual authentication with the removable memory device, to generate a cryptographic key on the basis of the base data written to the protected area of the removable memory device and the sub data written to the data write area if the authentication is confirmed, and to decrypt encrypted content distributed by a content server on the basis of the cryptographic key for performing streaming play of the content.

2. A content player device comprising:
a memory;
one or more hardware processors coupled to the memory;
a first transceiver coupled to the one or more hardware processors and configured to be connected to an external network; and
a second transceiver coupled to the first transceiver and configured to be connected to a removable memory device, the removable memory device being configured to be connected to a license server on the external network in a mutually authenticated manner via the first and second transceiver if the removable memory device is connected to the second transceiver, the license server being configured to distribute base data including a group of cryptographic keys, and the removable memory device being configured to receive the base data from the license server if the removable memory device is connected to the second transceiver, wherein the one or more hardware processors are configured to:
write the preliminarily provided base data to a protected area of the removable memory device;
perform mutual authentication with the removable memory device;
receive encrypted content including sub data representing a cryptographic key in the group of cryptographic keys of the base data distributed by a content server if the authentication is confirmed;
select a cryptographic key from the group of cryptographic keys of the base data written to the protected area of the removable memory device on the basis of the sub data; and
decrypt the encrypted content on the basis of the cryptographic key for performing streaming play of the content.

3. The content player device of claim 2, wherein the cryptographic key is selected on the basis of the number of streamed bytes.

4. A content player device comprising:
a memory;
one or more hardware processors coupled to the memory;
a first transceiver coupled to the one or more hardware processors and configured to be connected to an external network; and
a second transceiver coupled to the first transceiver and configured to be connected to a removable memory device, the removable memory device being configured to be connected to a license server on the external network in a mutually authenticated manner via the first and second transceiver if the removable memory device is connected to the second transceiver, the license server being configured to distribute base data including a group of cryptographic keys and sub data representing a cryptographic key in the group of cryptographic key of the base data, and the removable memory device being configured to receive the base data and the sub data from the license server if the removable memory device is connected to the second transceiver, wherein the one or more hardware processors are configured to:
write the preliminarily provided base data to a protected area of the removable memory device and to write the sub data to a data write area of the removable memory device using a command which allows a write only in an authentication mode;
perform mutual authentication with the removable memory device;
select a cryptographic key from the group of cryptographic keys of the base data written to the protected area of the removable memory device on the basis of the sub data written to the data write area if the authentication is confirmed; and
decrypt encrypted content distributed by a content server on the basis of the cryptographic key for performing streaming play of the content.

5. The content player device of claim 4, wherein the cryptographic key is selected on the basis of the number of streamed bytes.

6. A content playing method comprising:
connecting a license server with a removable memory device in a mutually authenticated manner, the license server being configured to distribute base data used for generating a cryptographic key and sub data which generate the cryptographic key on the basis of the base data, and the removable memory device being configured to receive the base data and the sub data from the license server;
writing the preliminarily provided base data to a protected area of the removable memory device and writing the sub data to a data write area of the removable memory device in response to a command which allows a write only in an authentication mode; and
performing mutual authentication with the removable memory device, generating a cryptographic key on the basis of the base data written to the protected area of the removable memory device and the sub data written to the data write area if the authentication is confirmed, and decrypting encrypted content distributed by a content server on the basis of the cryptographic key for performing streaming play of the content.

7. A content playing method comprising:
connecting a license server with a removable memory device in a mutually authenticated manner, the license server configured to distribute base data including a group of cryptographic keys, and the removable memory device being configured to receive the base data from the license server;
writing the preliminarily provided base data to a protected area of the removable memory device; and
performing mutual authentication with the removable memory device, receiving encrypted content including sub data representing a cryptographic key in the group of cryptographic keys of the base data distributed by a content server if the authentication is confirmed, selecting a cryptographic key from the group of cryptographic keys of the base data written to the protected area of the removable memory device on the basis of the sub data, and decrypting the encrypted content on the basis of the cryptographic key for performing streaming play of the content.

8. The content playing method of claim 7, wherein the cryptographic key is selected on the basis of the number of streamed bytes.

9. A content playing method comprising:
connecting a license server with a removable memory device in a mutually authenticated manner, the license server configured to distribute base data including a group of cryptographic keys and sub data representing a cryptographic key in the group of cryptographic key, and the removable memory device being configured to receive the base data and the sub data from the license server;
writing the preliminarily provided base data to a protected area of the removable memory device and writing the sub data to a data write area of the removable memory device using a command which allows a write only in an authentication mode; and
performing mutual authentication with the removable memory device, selecting a cryptographic key from the group of cryptographic keys of the base data written to the protected area of the removable memory device on the basis of the sub data written to the data write area if the authentication is confirmed, and decrypting encrypted content distributed by a content server on the basis of the cryptographic key for performing streaming play of the content.

10. The content playing method of claim 9, wherein the cryptographic key is selected on the basis of the number of streamed bytes.
